(19) United States
(12) Patent Application Publication
(10) Pub. No.: US 2025/0088644 A1
(43) Pub. Date: Mar. 13, 2025

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Meng WANG, Hong Kong (CN); Kai Zhang, Los Angeles, CA (US); Li Zhang, Los Angeles, CA (US); Xiaohan Fang, Beijing (CN)

(21) Appl. No.: 18/957,519

(22) Filed: Nov. 22, 2024

Related U.S. Application Data
(63) Continuation of application No. PCT/CN2023/095636, filed on May 22, 2023.

(30) Foreign Application Priority Data
May 23, 2022 (WO) PCT/CN2022/094567

(51) Int. Cl. H04N 19/167; H04N 19/119; H04N 19/42

(52) U.S. Cl. CPC H04N 19/167; H04N 19/119; H04N 19/42

(57) ABSTRACT

Embodiments of the disclosure provide a solution for video processing. A method for video processing is proposed. The method includes: applying, during a conversion between a video unit of a video and a bitstream of the video, a signal process to the video unit based at least in part on a window-based attention module; and performing the conversion based on the processed video unit.

### CROSS-REFERENCE TO RELATED APPLICATIONS

This application is a continuation of International Application No. PCT/CN2023/095636, filed on May 22, 2023, which claims the benefit of International Application No. PCT/CN2022/094567 filed on May 23, 2022. The entire contents of these applications are hereby incorporated by reference in their entireties.

### FIELDS

Embodiments of the present disclosure relates generally to video processing techniques, and more particularly, to learned image compression.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: applying, during a conversion between a video unit of a video and a bitstream of the video, a signal process to the video unit based at least in part on a window-based attention module; and performing the conversion based on the processed video unit. The method in accordance with the first aspect of the present disclosure can achieve more compact signal representation and exquisite recovery.

In a second aspect, another method for video processing is proposed. The method comprises: applying, during a conversion between a video unit of a video and a bitstream of the video, a data augmentation process for training a window-based attention module; performing a signal process on the video unit based on the trained window-based attention module; and performing the conversion based on the processed video unit. The method in accordance with the second aspect of the present disclosure can achieve a better window-based attention module.

In a third aspect, an apparatus for video processing is proposed. The apparatus comprises a processor and a non-transitory memory with instructions thereon. The instructions upon execution by the processor, cause the processor to perform a method in accordance with the first aspect or the second aspect of the present disclosure.

In a fourth aspect, a non-transitory computer-readable storage medium is proposed. The non-transitory computer-readable storage medium stores instructions that cause a processor to perform a method in accordance with the first aspect or the second aspect of the present disclosure.

In a fifth aspect, another non-transitory computer-readable recording medium is proposed. The non-transitory computer-readable recording medium stores a bitstream of a video which is generated by a method performed by an apparatus for video processing. The method comprises applying a signal process to a video unit of the video based at least in part on a window-based attention module; and generating a bitstream of the video based on the processed video unit.

In a sixth aspect, a method for storing a bitstream of a video is proposed. The method comprises: applying a signal process to a video unit of the video based at least in part on a window-based attention module; generating a bitstream of the video based on the processed video unit; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by an apparatus for video processing. The method comprises: applying a data augmentation process for training a window-based attention module; performing a signal process on a video unit of the video based on the trained window-based attention module; and generating a bitstream of the video based on the processed video unit.

In an eighth aspect, a method for storing a bitstream of a video is proposed. The method comprises: applying a data augmentation process for training a window-based attention module; performing a signal process on a video unit of the video based on the trained window-based attention module; generating a bitstream of the video based on the processed video unit; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a framework in accordance with embodiments of the present disclosure;

FIG. 5 illustrates a structure swin-transformer based encoding block in accordance with embodiments of the present disclosure;

FIG. 6 illustrates a flowchart of a method for video processing in accordance with embodiments of the present disclosure;

FIG. 7 illustrates a flowchart of a method for video processing in accordance with embodiments of the present disclosure; and

FIG. 8 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

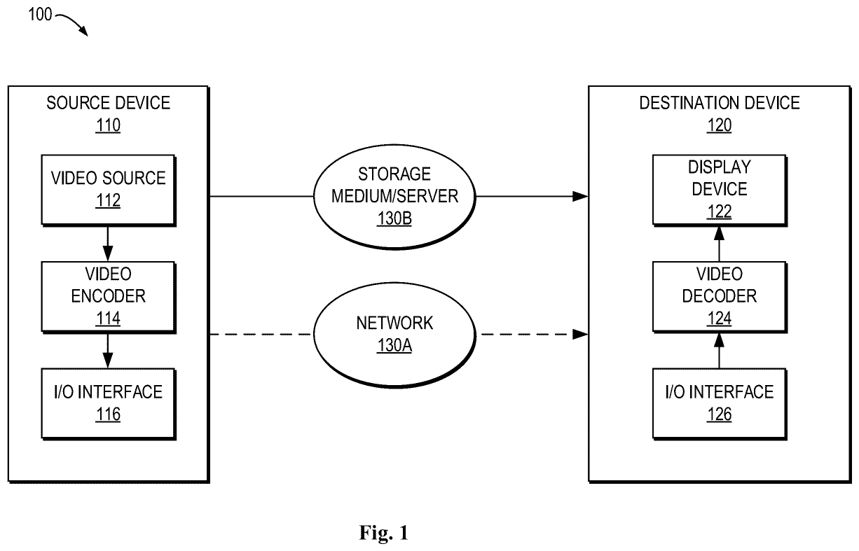

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

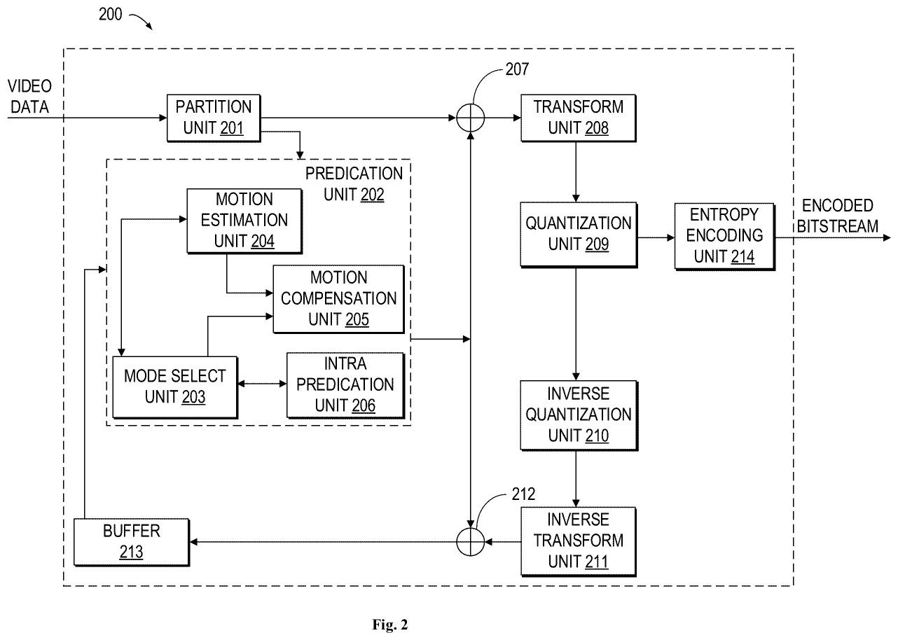

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

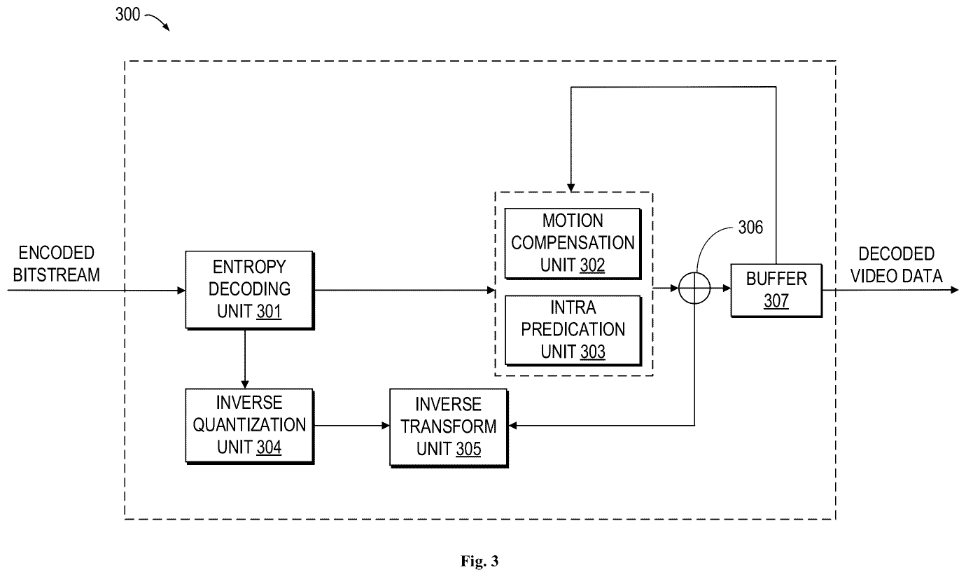

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

The present disclosure is related to image/video processing technologies. Specifically, it is about algorithm design for image compression. The ideas may be applied individually or in various combination, to any image/video coding system or part of coding and decoding process.

### 2. INTRODUCTION

Image compression plays a more prominent role in handling the ever-increasing image data volume. A series of efforts have been dedicated to improving the compression efficiency in the literature and industry field. The traditional lossy image compression standards including the JPEG2000, BPG and VVC are developed in the past several decades based on the block-wise hybrid coding framework. Traditional coding schemes includes advanced prediction module, 2D transformation, scalar quantization, arithmetic entropy coding, and loop filters, such that the redundant information in image could be efficiently eliminated.

With the surging of the deep learning, learning-based strategies have penetrated the image compression. Variational auto-encoder (VAE) was reported to achieve astonishing compression performance in comparison to the traditional coding methods, demonstrating the compression potential of end-to-end optimized coding schemes. Typically, the end-to-end compression framework involves convolution operations and Generalized Divisive Normalization (GDN), such that the visual signals are linearly and non-linearly transformed as the latent code and synthesized back to the reconstructed visual signals. The latent code is compressed into the bitstream with entropy coding. The network could be optimized in a globally end-to-end manner targeting at minimizing the rate and distortion cost. In the literature, a series of efforts have been conducted to enhancing the rate distortion performance of end-to-end image compression. Advanced probabilistic estimation and entropy coding schemes are proposed such as the hyper-prior model, joint auto-regressive model, entropy estimation with Gaussian mixture model. Vision transformer network has gradually brought into horizon and successfully applied to vision tasks, such as segmentation and restoration.

### 3. PROBLEMS

The main issue of the convolution-based schemes lies in the weakness of delicately local-wise analyzing, such that local details may be degraded with pure convolution-based end-to-end compression framework. As such, it is imperative to investigate new methods to enhance the compression performance.

### 4. DETAILED SOLUTIONS

To further enhance the rate and distortion performance, we propose a Transformer based End-to-end image Compression framework. The proposed method is constructed with interleaved transformer layers and convolutional layers, such that it could take both advantages of convolution operation for information distillation, and the advantages of the swin-transformer for localized analyzing and non-local perceiving, leading to more compact signal representation and exquisite recovery. In the following descriptions, the term ‘image compression’ may represent any variance of signal processing methods that compress or process the current input. The input images/videos include but not limited to the screen content and natural content.

To solve the problem, one or more of the following approaches are disclosed:
1. Introduce the transformer network to image and video restoration.
   a) In one example, the transformer network may be applied to image/video compression, including the traditional compression and learning-based compression schemes.
   b) In one example, the transformer network may be applied to image/video super-resolution.
   c) In one example, the transformer network may be applied to in-loop filtering in image/video compression.
   d) In one example, the transformer network may be applied to pre-processing and/or post-processing.
2. Introduce the combination of transformer network and convolutional network.
   a) In one example, the convolution layers in convolutional network may be replaced by transformer layers.
      i. In one example, the convolution layers in convolution-based end to end image/video compression networks can be replaced by transformer layers.
      ii. In one example, the convolution layers in convolution-based image/video super resolution networks can be replaced by transformer layers.
   b) In one example, the partial modules in convolutional network may be replaced by transformer network.
      i. In one example, the encoder in convolution-based end to end image/video compression networks can be replaced by transformer network.
      ii. In one example, the decoder in convolution-based end to end image/video compression networks can be replaced by transformer network.
      iii. The residual blocks in image/video super resolution networks can be replaced by transformer network.
3. Introduce the transformer network to the end-to-end compression framework.
   a) In one example, the whole framework employs the transformer network to replace the convolutional-based backbones.
   b) In one example, the transformer layers could be a subset of the end-to-end compression framework, that cooperates with the convolutional layers.
4. Involve the transformer network in the encoding process.
   a) In one example, the transformer network is directly applied to the visual images.
      i. In one example, the transformer splits the input images as p×p patches when extracting the window-based attention, and the size of the output of the transformer is identical to the input.
         1) In one example, p equals to 2″.
         2) In one example, p equals 8.
      ii. In one example, the transformer splits the input images as p×p patches when extracting the window-based attention, and the h is smaller than that of the input.
         1) In one example, p equals to 2″.
         2) In one example, p equals 8.
         3) In one example, the output feature size is half of the input size.
         4) In one example, the output feature size is ¼ of the input size.
   b) In one example, the transformer is applied to features. The channel number of input features is denoted as N.
      i. In one example, the transformer splits the input features as p×p patches when extracting the window-based attention, and the spatial size of the output of the transformer is identical to the input.
         1) In one example, p equals to 2″.
         2) In one example, p equals 8.
         3) In one example, the channel number of the output features is identical to N.
         4) In one example, the channel number of the output features is smaller than N.
         5) In one example, the channel number of the output features is larger than N.
      ii. In one example, the transformer splits the input features as p×p patches when extracting the window-based attention, and the size of the output of the transformer is smaller than that of the input.
         1) In one example, p equals to 2″.
         2) In one example, p equals 8.
         3) In one example, the output feature size is half of the input size.
         4) In one example, the output feature size is ¼ of the input size.
         5) In one example, the channel number of the output features is identical to N.
         6) In one example, the channel number of the output features is smaller than N.
         7) In one example, the channel number of the output features is larger than N.
5. Involve the transformer layer in the decoding process.
   a) In one example, the transformer network is directly applied to the latent feature maps.
      i. In one example, the transformer splits the latent feature maps as p×p patches when extracting the window-based attention, and the size of the output of the transformer is identical to the input.
         1) In one example, p equals to 2″.
         2) In one example, p equals 8.
      ii. In one example, the transformer splits the latent feature maps as p×p patches when extracting the window-based attention, and the size of the output of the transformer is larger than that of the input.
         1) In one example, p equals to 2″.
         2) In one example, p equals 8.
         3) In one example, the output feature size is double of the input size.
         4) In one example, the output feature size is four times of the input size.
   b) In one example, the transformer is applied to features. The channel number of input features is denoted as N.
      i. In one example, the transformer splits the input features as p×p patches when extracting the window-based attention, and the spatial size of the output of the transformer is identical to the input.
         1) In one example, p equals to 2″.
         2) In one example, p equals 8.
         3) In one example, the channel number of the output features is identical to N.
         4) In one example, the channel number of the output features is smaller than N.
         5) In one example, the channel number of the output features is larger than N.
      ii. In one example, the transformer splits the input features as p×p patches when extracting the window-based attention, and the size of the output of the transformer is smaller than that of the input.
         1) In one example, p equals to 2″.
         2) In one example, p equals 8.
         3) In one example, the output feature size is half of the input size.
         4) In one example, the output feature size is ¼ of the input size.
         5) In one example, the channel number of the output features is identical to N.
         6) In one example, the channel number of the output features is smaller than N.
         7) In one example, the channel number of the output features is larger than N.
6. Data augmentation strategies are proposed to enhance the learning process of the compression or restoration.
   a) In one example, only natural scene images/videos are employed for training the network.
   b) In one example, only game scene images/videos are employed for training the network.
   c) In one example, natural scene and game scene images/videos are mixed as the training set, which contains x % game scene images/videos, and (1−x %) natural scene images/videos.
   d) In one example, the network is first trained with natural scene images/videos, and then finetuned with game scene images/videos.
   e) Alternatively for example, the network is first trained with game scene images/videos, and then finetuned with natural scene images/videos.

### 5. EMBODIMENTS

Examples of end-to-end image compression process are illustrated as follows. Swin-transformer based encoding blocks and swin-transformer based decoding blocks are involved in the compression network. The inputs could be color pictures/frames/videos with three channels (e.g. RGB, YUV) or signal channel pictures/frames/videos.

### Embodiment #1

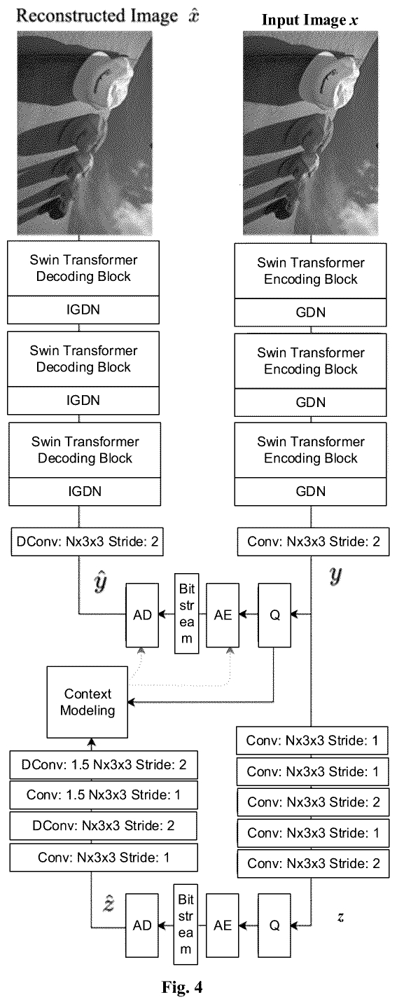

In this embodiment, as shown in FIG. 4, the encoding analysis branch is composed with sequentially connected swin-transformer based encoding blocks. GDN layers are attached as activating functions. Analogously, the decoding synthesis branch are stacked with swin-transformer based decoding blocks and IGDN layers. The joint auto-regressive entropy coding module and context modeling module are employed for more accurate probabilistic estimation. The swin-transformer based decoding block shares similar architecture with the encoding block except that the last convolution layer is replaced by a deconvolution layer with stride 2 which enlarges the spatial scales of the reconstructed feature maps.

Supposing the input of the i-th swin-transformer based encoding block is xᵢ with the size of W×H×N, the feature forward projection firstly applies to xᵢ, converting the input signals to higher-dimensional feature space but with more compact representation fᵢ. The dimension of fᵢ is W×H×E, where E should be smaller than N. Subsequently, swin-transformer layer is employed, with the goal of conducting more delicate localized prediction. Then, a convolution layer is cooperated with residual skip connection. Feature backward projection is conducted, which projects the features back to the same dimension as the input xᵢ. Last, a convolution layer with stride 2 is involved, which shrinks the spatial scale of the feature maps. The output is the xᵢ₊₁ which serves as the input of the next stage.

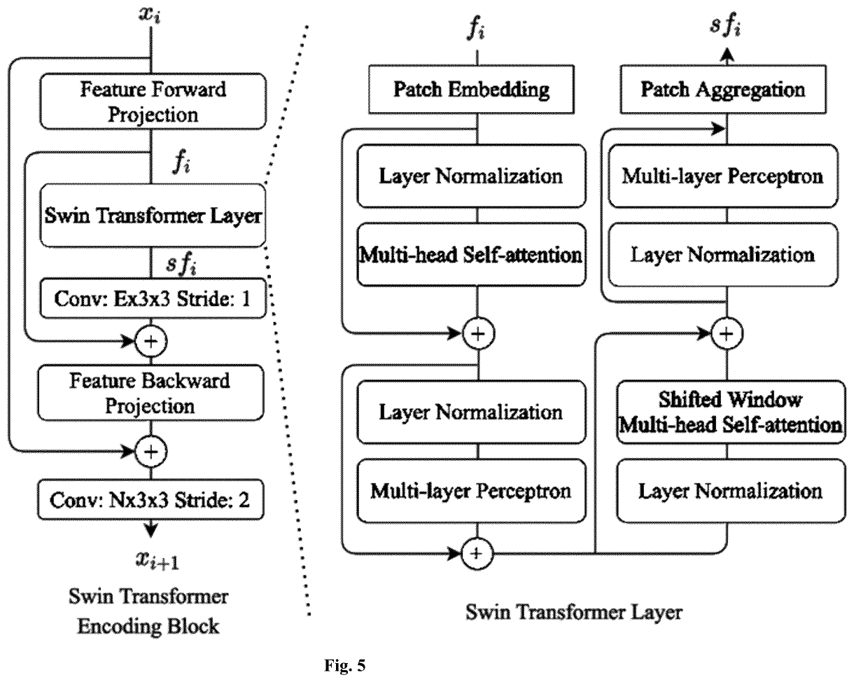

The details of the swin transformer layer is illustrated in FIG. 5. More specifically, the swin-transform layer is built upon the multi-head self attention extraction, where shifted window self-attention is obscured to achieve cross-window de-correlation in the second phase. Given the features fᵢ with the size of W×H×E, patch embedding is conducted that splits the input features as a collection of non-overlapping p×p patches. As such, fᵢ is embedded as patch-based features. Herein, p×p is the patch size which corresponds to the window size. The self-attention is calculated individually within each window. In particular, layer normalization and multi-head self-attention is conducted to extract the local attentions. Meanwhile, multi-layer perception is used following a layer normalization. Next, window is shifted by p/2 horizontally and vertically, and the local attention within the shifted windows are calculated. Residual skip connections are employed. At last, window-based patches are aggregated, resulting in the sfᵢ.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. The term “image compression” may represent any variance of signal processing methods that compress or process the current input. The input images/videos include but not limited to the screen content and natural content.

The term “window-based attention module” used herein is a model in nature language processing and may be also referred to as “transformer.” The terms “window-based attention module” and “transformer” can be used interchangeable hereinafter.

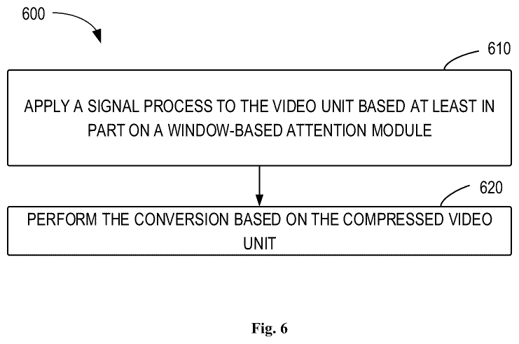

FIG. 6 illustrates a flowchart of a method 600 for video processing in accordance with embodiments of the present disclosure. The method 600 is implemented during a conversion between a video unit of a video and a bitstream of the video.

At block 610, for a conversion between a video unit of a video and a bitstream of the video, a signal process is applied to the video unit based at least in part on a window-based attention module. The window-based attention module may be applied at different stages during the conversion. For example, the window-based attention module may be located at different positions in an encoder and/or a decoder.

At block 620, the conversion is performed based on the processed video unit. In some embodiments, the conversion may include encoding the video unit into the bitstream. Alternatively, or in addition, the conversion may include decoding the video unit from the bitstream. The method 600 can combine interleaved transformer layers and convolutional layers, such that it could take both advantages of convolution operation for information distillation, and the advantages of the swin-transformer for localized analyzing and non-local perceiving, thereby leading to more compact signal representation and exquisite recovery.

In some embodiments, the signal process comprises a restoration of the video unit. In some embodiments, the window-based attention module is applied to a compression of the video unit. The compression may comprise a non-learning-based compression and a learning based compression. In one example, the transformer network may be applied to image/video compression, including the traditional compression and learning-based compression schemes.

In some embodiments, the window-based attention module is applied to a super-resolution of the video unit. In some embodiments, the window-based attention module is applied to an in-loop filtering in a compression of the video unit. Alternatively, the window-based attention module is applied to at least one of: a pre-processing or a post-processing of the video unit.

In some embodiments, applying the signal processing comprises: applying the signal processing to the video unit based on a combination of the window-based attention module and a convolutional network. For example, the window-based attention module and the convolutional network can be combined.

In some embodiments, a convolution layer in the convolutional network is replaced by a layer of the window-based attention module. In some embodiments, the convolutional network comprises a convolution-based compression network, and a convolution layer of the convolutional based compression network is replaced by the layer of the window-based attention module. In some embodiments, the convolutional network comprises a convolution based super resolution network, and a convolution layer of the convolution based super resolution network is replaced by the layer of the window-based attention module.

In some embodiments, a portion of modules in the convolutional network is replaced by the window-based attention module. In some embodiments, the convolutional network comprises a convolution-based compression network, and an encoder in the convolution-based compression network is replaced by the window-based attention module. In some other embodiments, the convolutional network comprises a convolution-based compression network, and a decoder in the convolution-based compression network is replaced by the window-based attention module. In some further embodiments, the convolutional network comprises a super resolution network, and a residual block in the super resolution network is replaced by the window-based attention module.

In some embodiments, the window-based attention module is applied in a compression framework. In some embodiments, the compression framework uses the window-based attention module to replace a convolution-based network. In some other embodiments, a layer of the window-based attention module is a subset of the compression framework that cooperates with a convolutional layer.

In some embodiments, the signal process is an encoding process, and the window-based attention module is applied in the encoding process. In some embodiments, the window-based attention module is directly applied to a visual image of the video unit.

In some embodiments, the window-based attention module splits an input image as p×p patches when extracting a window-based attention, and a size of an output feature of the window-based attention module is identical to the input image. In this case, p may be an integer number. In some embodiments, p equals to 2″, and n may be an integer number. Alternatively, p equals 8.

In some embodiments, the window-based attention module splits an input image as p×p patches when extracting a window-based attention, and a size of an output feature of the window-based attention module is smaller than the input image, wherein p is an integer number. In some embodiments, p equals to 2″, and where n is an integer number. In some embodiments, p equals to 8. In some embodiments, the size of the output image is a half of an input size. In some embodiments, the size of the output image is a quarter of the input size.

In some embodiments, the window-based attention module is applied to features of the video unit. In some embodiments, the window-based attention module splits an input feature as p×p patches when extracting a window-based attention, and a spatial size of an output feature of the window-based attention module is identical to the input feature. In this case, p may be an integer number. In some embodiments, p equals to 2″, and where n is an integer number. Alternatively, p equals to 8.

In some embodiments, the window-based attention module splits an input feature as p×p patches when extracting a window-based attention, and a size of an output feature of the window-based attention module is smaller than the input feature. In this case, p may be an integer number. In some embodiments, p equals to 2″, and where n is an integer number. Alternatively, p equals to 8. In some embodiments, the size of the output feature is a half of an input size. In some embodiments, the size of the output feature is a quarter of the input size.

In some embodiments, a channel number of the output feature is identical to a channel number of the input feature. In some other embodiments, a channel number of the output feature is smaller than the channel number of the input feature. In some embodiments, a channel number of the output feature is larger than the channel number of the input feature.

In some embodiments, the signal process is a decoding process, and the window-based attention module is applied in the decoding process. In some embodiments, the window-based attention module is directly applied to a latent feature map the video unit.

In some embodiments, the window-based attention module splits the latent feature map as p×p patches when extracting a window-based attention, and a size of an output feature of the window-based attention module is identical to an input latent feature of the window-based attention module. In this case, p may be an integer number. In some embodiments, p equals to 2″, and where n is an integer number. In some embodiments, p equals to 8.

In some embodiments, the window-based attention module splits the latent feature map as p×p patches when extracting a window-based attention, and a size of an output feature of the window-based attention module is larger than an input latent feature of the window-based attention module. In this case, p may be an integer number. In some embodiments, p equals to 2″, and where n is an integer number. In some embodiments, p equals to 8. In some embodiments, the size of the output is a double of an input size. In some embodiments, the size of the output is four times of the input size.

In some embodiments, the window-based attention module may be applied to features of the video unit. In some embodiments, the window-based attention module splits an input feature as p×p patches when extracting a window-based attention, and a spatial size of an output feature of the window-based attention module is identical to the input feature. In this case, p may be an integer number. In some embodiments, p equals to 2″, and where n is an integer number. In some embodiments, p equals to 8.

In some embodiments, the window-based attention module splits an input feature as p×p patches when extracting a window-based attention, and a size of an output feature of the window-based attention module is smaller than the input feature. In this case, p may be an integer number. In some embodiments, p equals to 2″, and where n is an integer number. In some embodiments, p equals to 8. In some embodiments, the size of the output feature is a half of an input size. In some embodiments, the size of the output feature is a quarter of the input size.

In some embodiments, a channel number of the output feature is identical to a channel number of the input feature. Alternatively, a channel number of the output feature is smaller than the channel number of the input feature. In some other embodiments, a channel number of the output feature is larger than the channel number of the input feature.

According to further embodiments of the present disclosure, a non-transitory computer-readable recording medium is provided. The non-transitory computer-readable recording medium stores a bitstream of a video which is generated by a method performed by an apparatus for video processing. The method comprises applying a signal process to a video unit of the video based at least in part on a window-based attention module; and generating a bitstream of the video based on the processed video unit.

According to still further embodiments of the present disclosure, a method for storing bitstream of a video is provided. The method comprises: applying a signal process to a video unit of the video based at least in part on a window-based attention module; generating a bitstream of the video based on the processed video unit; and storing the bitstream in a non-transitory computer-readable recording medium.

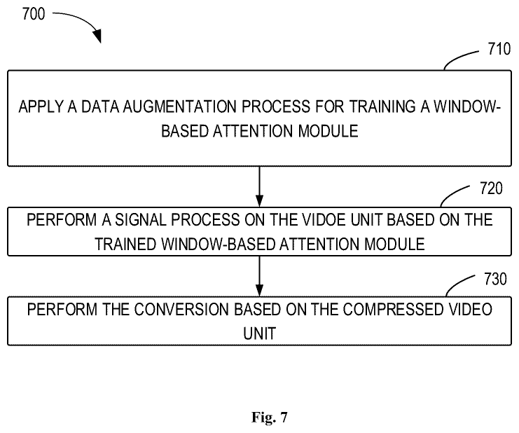

FIG. 7 illustrates a flowchart of a method 700 for video processing in accordance with embodiments of the present disclosure. The method 700 is implemented during a conversion between a video unit of a video and a bitstream of the video. In some embodiments, the method 700 may be implemented in a combination of the method 600. Alternatively, the method 700 may be implemented independently.

At block 710, during a conversion between a video unit of a video and a bitstream of the video, a data augmentation process is applied for training a window-based attention module. For example, data augmentation strategies may be used to enhance the learning process of the compression or restoration.

At block 720, a signal process is performed on the video unit based on the trained window-based attention module. For example, the signal process may be a compression process or a restoration process.

At block 730, the conversion is performed based on the processed video unit. In some embodiments, the conversion may include encoding the video unit into the bitstream. Alternatively, or in addition, the conversion may include decoding the video unit from the bitstream. The method 700 enables a proper training window-based attention module.

In some embodiments, only a nature scene video unit is employed for training the window-based attention module. In some embodiments, only a game scene video unit is employed for training the window-based attention module.

In some embodiments, nature scene video units and game scene video units are mixed as a training set for the window-based attention module. In some embodiments, the window-based attention module is first trained with a natural scene video unit and then fined tuned with a game scene video unit. In one example, natural scene and game scene images/videos are mixed as the training set, which contains x % game scene images/videos, and (1−x %) natural scene images/videos. In some embodiments, the window-based attention module is first trained with a game scene video unit and then fined tuned with a natural scene video unit.

According to further embodiments of the present disclosure, a non-transitory computer-readable recording medium is provided. The non-transitory computer-readable recording medium stores a bitstream of a video which is generated by a method performed by an apparatus for video processing. The method comprises: applying a data augmentation process for training a window-based attention module; performing a signal process on a video unit of the video based on the trained window-based attention module; and generating a bitstream of the video based on the processed video unit.

According to still further embodiments of the present disclosure, a method for storing bitstream of a video is provided. The method comprises applying a data augmentation process for training a window-based attention module; performing a signal process on a video unit of the video based on the trained window-based attention module; generating a bitstream of the video based on the processed video unit; and storing the bitstream in a non-transitory computer-readable recording medium.

Implementations of the present disclosure can be described in view of the following clauses, the features of which can be combined in any reasonable manner.

Clause 1. A method of video processing, comprising: applying, during a conversion between a video unit of a video and a bitstream of the video, a signal process to the video unit based at least in part on a window-based attention module; and performing the conversion based on the processed video unit.

Clause 2. The method of clause 1, wherein the signal process comprises a restoration of the video unit.

Clause 3. The method of clause 1, wherein the window-based attention module is applied to a compression of the video unit, and wherein the compression comprises a non-learning based compression and a learning based compression.

Clause 4. The method of clause 1, wherein the window-based attention module is applied to a super-resolution of the video unit.

Clause 5. The method of clause 1, wherein the window-based attention module is applied to an in-loop filtering in a compression of the video unit.

Clause 6. The method of clause 1, wherein the window-based attention module is applied to at least one of: a pre-processing or a post-processing of the video unit.

Clause 7. The method of clause 1, wherein applying the signal processing comprises: applying the signal processing to the video unit based on a combination of the window-based attention module and a convolutional network.

Clause 8. The method of clause 7, wherein a convolution layer in the convolutional network is replaced by a layer of the window-based attention module.

Clause 9. The method of clause 8, wherein the convolutional network comprises a convolution-based compression network, and a convolution layer of the convolutional based compression network is replaced by the layer of the window-based attention module.

Clause 10. The method of clause 8, wherein the convolutional network comprises a convolution based super resolution network, and a convolution layer of the convolution based super resolution network is replaced by the layer of the window-based attention module.

Clause 11. The method of clause 7, wherein a portion of modules in the convolutional network is replaced by the window-based attention module.

Clause 12. The method of clause 11, wherein the convolutional network comprises a convolution-based compression network, and an encoder in the convolution-based compression network is replaced by the window-based attention module.

Clause 13. The method of clause 11, wherein the convolutional network comprises a convolution-based compression network, and a decoder in the convolution-based compression network is replaced by the window-based attention module.

Clause 14. The method of clause 11, wherein the convolutional network comprises a super resolution network, and a residual block in the super resolution network is replaced by the window-based attention module.

Clause 15. The method of clause 1, wherein the window-based attention module is applied in a compression framework.

Clause 16. The method of clause 15, wherein the compression framework uses the window-based attention module to replace a convolution-based network.

Clause 17. The method of clause 15, wherein a layer of the window-based attention module is a subset of the compression framework that cooperates with a convolutional layer.

Clause 18. The method of clause 1, wherein the signal process is an encoding process, and the window-based attention module is applied in the encoding process.

Clause 19. The method of clause 18, wherein the window-based attention module is directly applied to a visual image of the video unit.

Clause 20. The method of clause 19, wherein the window-based attention module splits an input image as p×p patches when extracting a window-based attention, and a size of an output feature of the window-based attention module is identical to the input image, wherein p is an integer number.

Clause 21. The method of clause 20, wherein p equals to 2″, and wherein n is an integer number, or wherein p equals to 8.

Clause 22. The method of clause 19, wherein the window-based attention module splits an input image as p×p patches when extracting a window-based attention, and a size of an output feature of the window-based attention module is smaller than the input image, wherein p is an integer number.

Clause 23. The method of clause 22, wherein p equals to 2″, and wherein n is an integer number, or wherein p equals to 8, or wherein the size of the output image is a half of an input size, or wherein the size of the output image is a quarter of the input size.

Clause 24. The method of clause 18, wherein the window-based attention module is applied to features of the video unit.

Clause 25. The method of clause 24, wherein the window-based attention module splits an input feature as p×p patches when extracting a window-based attention, and a spatial size of an output feature of the window-based attention module is identical to the input feature, wherein p is an integer number.

Clause 26. The method of clause 25, wherein p equals to 2″, and wherein n is an integer number, or wherein p equals to 8.

Clause 27. The method of clause 24, wherein the window-based attention module splits an input feature as p×p patches when extracting a window-based attention, and a size of an output feature of the window-based attention module is smaller than the input feature, wherein p is an integer number.

Clause 28. The method of clause 27, wherein p equals to 2″, and wherein n is an integer number, or wherein p equals to 8, or wherein the size of the output feature is a half of an input size, or wherein the size of the output feature is a quarter of the input size.

Clause 29. The method of clause 26 or 28, wherein a channel number of the output feature is identical to a channel number of the input feature, or wherein a channel number of the output feature is smaller than the channel number of the input feature, or wherein a channel number of the output feature is larger than the channel number of the input feature.

Clause 30. The method of clause 1, wherein the signal process is a decoding process, and the window-based attention module is applied in the decoding process.

Clause 31. The method of clause 30, wherein the window-based attention module is directly applied to a latent feature map the video unit.

Clause 32. The method of clause 31, wherein the window-based attention module splits the latent feature map as p×p patches when extracting a window-based attention, and a size of an output feature of the window-based attention module is identical to an input latent feature of the window-based attention module, wherein p is an integer number.

Clause 33. The method of clause 32, wherein p equals to 2″, and wherein n is an integer number, or wherein p equals to 8.

Clause 34. The method of clause 31, wherein the window-based attention module splits the latent feature map as p×p patches when extracting a window-based attention, and a size of an output feature of the window-based attention module is larger than an input latent feature of the window-based attention module, wherein p is an integer number.

Clause 35. The method of clause 34, wherein p equals to 2″, and wherein n is an integer number, or wherein p equals to 8, or wherein the size of the output is a double of an input size, or wherein the size of the output is four times of the input size.

Clause 36. The method of clause 30, wherein the window-based attention module is applied to features of the video unit.

Clause 37. The method of clause 36, wherein the window-based attention module splits an input feature as p×p patches when extracting a window-based attention, and a spatial size of an output feature of the window-based attention module is identical to the input feature, wherein p is an integer number.

Clause 38. The method of clause 37, wherein p equals to 2″, and wherein n is an integer number, or wherein p equals to 8.

Clause 39. The method of clause 36, wherein the window-based attention module splits an input feature as p×p patches when extracting a window-based attention, and a size of an output feature of the window-based attention module is smaller than the input feature, wherein p is an integer number.

Clause 40. The method of clause 39, wherein p equals to 2″, and wherein n is an integer number, or wherein p equals to 8, or wherein the size of the output feature is a half of an input size, or wherein the size of the output feature is a quarter of the input size.

Clause 41. The method of clause 38 or 40, wherein a channel number of the output feature is identical to a channel number of the input feature, or wherein a channel number of the output feature is smaller than the channel number of the input feature, or wherein a channel number of the output feature is larger than the channel number of the input feature.

Clause 42. A method of video processing, comprising: applying, during a conversion between a video unit of a video and a bitstream of the video, a data augmentation process for training a window-based attention module; performing a signal process on the video unit based on the trained window-based attention module; and performing the conversion based on the processed video unit.

Clause 43. The method of clause 42, wherein only a nature scene video unit is employed for training the window-based attention module, or wherein only a game scene video unit is employed for training the window-based attention module.

Clause 44. The method of clause 42, wherein nature scene video units and game scene video units are mixed as a training set for the window-based attention module.

Clause 45. The method of clause 42, wherein the window-based attention module is first trained with a natural scene video unit and then fined tuned with a game scene video unit.

Clause 46. The method of clause 42, wherein the window-based attention module is first trained with a game scene video unit and then fined tuned with a natural scene video unit.

Clause 47. The method of any of clauses 1-46, wherein the conversion includes encoding the video unit into the bitstream.

Clause 48. The method of any of clauses 1-46, wherein the conversion includes decoding the video unit from the bitstream.

Clause 49. An apparatus for video processing comprising a processor and a non-transitory memory with instructions thereon, wherein the instructions upon execution by the processor, cause the processor to perform a method in accordance with any of clauses 1-48.

Clause 50. A non-transitory computer-readable storage medium storing instructions that cause a processor to perform a method in accordance with any of clauses 1-48.

Clause 51. A non-transitory computer-readable recording medium storing a bitstream of a video which is generated by a method performed by an apparatus for video processing, wherein the method comprises applying a signal process to a video unit of the video based at least in part on a window-based attention module; and generating a bitstream of the video based on the processed video unit.

Clause 52. A method for storing a bitstream of a video, comprising: applying a signal process to a video unit of the video based at least in part on a window-based attention module; generating a bitstream of the video based on the processed video unit; and storing the bitstream in a non-transitory computer-readable recording medium.

Clause 53. A non-transitory computer-readable recording medium storing a bitstream of a video which is generated by a method performed by an apparatus for video processing, wherein the method comprises: applying a data augmentation process for training a window-based attention module; performing a signal process on a video unit of the video based on the trained window-based attention module; and generating a bitstream of the video based on the processed video unit.

Clause 54. A method for storing a bitstream of a video, comprising applying a data augmentation process for training a window-based attention module; performing a signal process on a video unit of the video based on the trained window-based attention module; generating a bitstream of the video based on the processed video unit; and storing the bitstream in a non-transitory computer-readable recording medium.

### Example Device

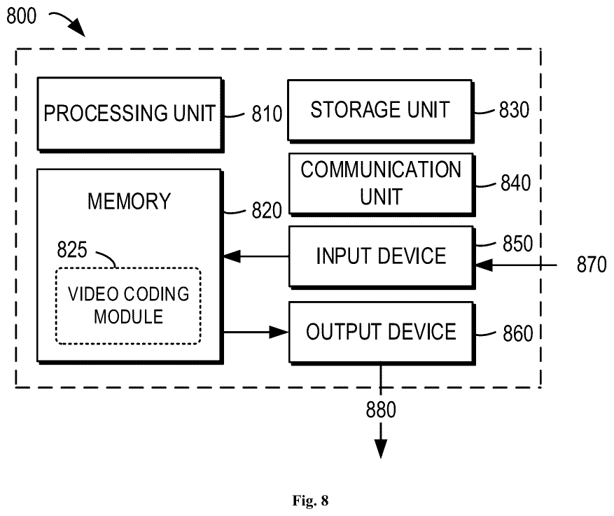

FIG. 8 illustrates a block diagram of a computing device 800 in which various embodiments of the present disclosure can be implemented. The computing device 800 may be implemented as or included in the source device 110 (or the video encoder 114 or 200) or the destination device 120 (or the video decoder 124 or 300).

It would be appreciated that the computing device 800 shown in FIG. 8 is merely for purpose of illustration, without suggesting any limitation to the functions and scopes of the embodiments of the present disclosure in any manner.

As shown in FIG. 8, the computing device 800 includes a general-purpose computing device 800. The computing device 800 may at least comprise one or more processors or processing units 810, a memory 820, a storage unit 830, one or more communication units 840, one or more input devices 850, and one or more output devices 860.

In some embodiments, the computing device 800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 800 can support any type of interface to a user (such as “wearable” circuitry and the like).

The processing unit 810 may be a physical or virtual processor and can implement various processes based on programs stored in the memory 820. In a multi-processor system, multiple processing units execute computer executable instructions in parallel so as to improve the parallel processing capability of the computing device 800. The processing unit 810 may also be referred to as a central processing unit (CPU), a microprocessor, a controller or a microcontroller.

The computing device 800 typically includes various computer storage medium. Such medium can be any medium accessible by the computing device 800, including, but not limited to, volatile and non-volatile medium, or detachable and non-detachable medium. The memory 820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 830 may be any detachable or non-detachable medium and may include a machine-readable medium such as a memory, flash memory drive, magnetic disk or another other media, which can be used for storing information and/or data and can be accessed in the computing device 800.

The computing device 800 may further include additional detachable/non-detachable, volatile/non-volatile memory medium. Although not shown in FIG. 8, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 840 communicates with a further computing device via the communication medium. In addition, the functions of the components in the computing device 800 can be implemented by a single computing cluster or multiple computing machines that can communicate via communication connections. Therefore, the computing device 800 can operate in a networked environment using a logical connection with one or more other servers, networked personal computers (PCs) or further general network nodes.

The input device 850 may be one or more of a variety of input devices, such as a mouse, keyboard, tracking ball, voice-input device, and the like. The output device 860 may be one or more of a variety of output devices, such as a display, loudspeaker, printer, and the like. By means of the communication unit 840, the computing device 800 can further communicate with one or more external devices (not shown) such as the storage devices and display device, with one or more devices enabling the user to interact with the computing device 800, or any devices (such as a network card, a modem and the like) enabling the computing device 800 to communicate with one or more other computing devices, if required. Such communication can be performed via input/output (I/O) interfaces (not shown).

In some embodiments, instead of being integrated in a single device, some or all components of the computing device 800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 800 may be used to implement video encoding/decoding in embodiments of the present disclosure. The memory 820 may include one or more video coding modules 825 having one or more program instructions. These modules are accessible and executable by the processing unit 810 to perform the functionalities of the various embodiments described herein.

In the example embodiments of performing video encoding, the input device 850 may receive video data as an input 870 to be encoded. The video data may be processed, for example, by the video coding module 825, to generate an encoded bitstream. The encoded bitstream may be provided via the output device 860 as an output 880.

In the example embodiments of performing video decoding, the input device 850 may receive an encoded bitstream as the input 870. The encoded bitstream may be processed, for example, by the video coding module 825, to generate decoded video data. The decoded video data may be provided via the output device 860 as the output 880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
applying, during a conversion between a video unit of a video and a bitstream of the video, a signal process to the video unit based at least in part on a window-based attention module; and
performing the conversion based on the processed video unit.

2. The method of claim 1, wherein the signal process comprises a restoration of the video unit, or
wherein the window-based attention module is applied to a compression of the video unit, and the compression comprises a non-learning based compression and a learning based compression, or
wherein the window-based attention module is applied to a super-resolution of the video unit, or
wherein the window-based attention module is applied to an in-loop filtering in the compression of the video unit, or
wherein the window-based attention module is applied to at least one of: a pre-processing or a post-processing of the video unit, or
wherein the window-based attention module is applied in a compression framework.

3. The method of claim 1, wherein applying the signal process comprises:
applying the signal process to the video unit based on a combination of the window-based attention module and a convolutional network.

4. The method of claim 3, wherein a convolution layer in the convolutional network is replaced by a layer of the window-based attention module, or
wherein a portion of modules in the convolutional network is replaced by the window-based attention module.

5. The method of claim 4, wherein the convolutional network comprises a convolution-based compression network, and a convolution layer of the convolution-based compression network is replaced by the layer of the window-based attention module, or
wherein the convolutional network comprises a convolution-based super resolution network, and a convolution layer of the convolution-based super resolution network is replaced by the layer of the window-based attention module, or
wherein the convolutional network comprises the convolution-based compression network, and an encoder in the convolution-based compression network is replaced by the window-based attention module, or
wherein the convolutional network comprises the convolution-based compression network, and a decoder in the convolution-based compression network is replaced by the window-based attention module, or
wherein the convolutional network comprises a super resolution network, and a residual block in the super resolution network is replaced by the window-based attention module.

6. The method of claim 1, wherein the signal process is an encoding process, and the window-based attention module is applied in the encoding process, or
wherein the signal process is a decoding process, and the window-based attention module is applied in the decoding process.

7. The method of claim 6, wherein a compression framework uses the window-based attention module to replace a convolution-based network, or
wherein a layer of the window-based attention module is a subset of the compression framework that cooperates with a convolutional layer, or
wherein the window-based attention module is directly applied to a visual image of the video unit, or
wherein the window-based attention module is applied to features of the video unit.

8. The method of claim 7, wherein the window-based attention module splits an input image as p×p patches when extracting a window-based attention, and a size of an output feature of the window-based attention module is identical to the input image, wherein p is an integer number, or
wherein the window-based attention module splits the input image as the p×p patches when extracting the window-based attention, and the size of the output feature of the window-based attention module is smaller than the input image, wherein p is an integer number, or
wherein the window-based attention module splits an input feature as the p×p patches when extracting the window-based attention, and a spatial size of the output feature of the window-based attention module is identical to the input feature, wherein p is an integer number, or
wherein the window-based attention module splits the input feature as the p×p patches when extracting the window-based attention, and the size of the output feature of the window-based attention module is smaller than the input feature, wherein p is an integer number.

9. The method of claim 8, wherein p equals to 2″, and wherein n is an integer number, or wherein p equals to 8, or
wherein p equals to 2″, and wherein n is an integer number, or wherein p equals to 8, or wherein a size of an output image is a half of an input size, or wherein the size of the output image is a quarter of the input size.

10. The method of claim 9, wherein a channel number of the output feature is identical to a channel number of the input feature, or
wherein the channel number of the output feature is smaller than the channel number of the input feature, or
wherein the channel number of the output feature is larger than the channel number of the input feature.

11. The method of claim 6, wherein the window-based attention module is directly applied to a latent feature map the video unit, or
wherein the window-based attention module is applied to features of the video unit.

12. The method of claim 11, wherein the window-based attention module splits the latent feature map as p×p patches when extracting a window-based attention, and a size of an output feature of the window-based attention module is identical to an input latent feature of the window-based attention module, wherein p is an integer number, or
wherein the window-based attention module splits the latent feature map as the p×p patches when extracting the window-based attention, and the size of the output feature of the window-based attention module is larger than the input latent feature of the window-based attention module, wherein p is an integer number, or
wherein the window-based attention module splits the input feature as the p×p patches when extracting the window-based attention, and a spatial size of the output feature of the window-based attention module is identical to the input feature, wherein p is an integer number, or
wherein the window-based attention module splits the input feature as the p×p patches when extracting the window-based attention, and the size of the output feature of the window-based attention module is smaller than the input feature, wherein p is an integer number.

13. The method of claim 12, wherein p equals to 2″, and wherein n is an integer number, or wherein p equals to 8, or
wherein p equals to 2″, and wherein n is an integer number, or wherein p equals to 8, or wherein the size of the output feature is a double of an input size, or wherein the size of the output feature is four times of the input size, or wherein the size of the output feature is a half of the input size, or wherein the size of the output feature is a quarter of the input size.

14. The method of claim 13, wherein a channel number of the output feature is identical to a channel number of the input feature, or wherein the channel number of the output feature is smaller than the channel number of the input feature, or wherein the channel number of the output feature is larger than the channel number of the input feature.

15. The method of claim 1, wherein a data augmentation process for training the window-based attention module is applied and the signal process is performed on the video unit based on the trained window-based attention module.

16. The method of claim 15, wherein only a nature scene video unit is employed for training the window-based attention module, or wherein only a game scene video unit is employed for training the window-based attention module, or
wherein nature scene video units and game scene video units are mixed as a training set for the window-based attention module, or
wherein the window-based attention module is first trained with a natural scene video unit and then fined tuned with the game scene video unit, or
wherein the window-based attention module is first trained with the game scene video unit and then fined tuned with the natural scene video unit.

17. The method of claim 1, wherein the conversion includes encoding the video unit into the bitstream, or
wherein the conversion includes decoding the video unit from the bitstream.

18. An apparatus for video processing comprising a processor and a non-transitory memory with instructions thereon, wherein the instructions upon execution by the processor, cause the processor to:
apply a signal process to a video unit of a video based at least in part on a window-based attention module; and
perform a conversion based on the processed video unit.

19. A non-transitory computer-readable storage medium storing instructions that cause a processor to:
apply a signal process to a video unit of a video based at least in part on a window-based attention module; and
perform a conversion based on the processed video unit.

20. A non-transitory computer-readable recording medium storing a bitstream of a video which is generated by a method performed by an apparatus for video processing, wherein the method comprises:
applying a signal process to a video unit of the video based at least in part on a window-based attention module; and
generating the bitstream of the video based on the processed video unit.
